(19) United States
(12) Patent Application Publication
(10) Pub. No.: US 2008/0190770 A1
(43) Pub. Date: Aug. 14, 2008

(54) Treatment of Fluids and/or Sludge with Electro Plasma

(75) Inventors: Edward O. Daigle, Covington, LA (US); Pankaj Gupta, Minnetonka, MN (US); Gregory J. Tenhundfeld, Baton Rouge, LA (US)

Correspondence Address: WARNER J DELAUNE JR;Baker Donelson Bearman Caldwell & Berkowitz, 301 N. Main Street, Suite 810, Baton Rouge, LA, 70825, US

(73) Assignee: CAP TECHNOLOGIES, LLC, Baton Rouge, LA (US)

(21) Appl. No.: 11/587,802

(22) PCT Filed: Apr. 26, 2005
(86) PCT No.: PCT/US2005/014382

§ 371 Date: Jan. 9, 2008

Related U.S. Application Data
(60) Provisional application No. 60/565,417, filed on Apr. 26, 2004.

(51) Int. Cl. B01D 57/00

(52) U.S. Cl. 204/554; 204/672

(57) ABSTRACT

A process for the treatment and/or removal from Condenser of contaminants from a waste water, waste stream, industrial or municipal sludge, metals, oils, organics and other materials consider to be harmful to the environment are removed from the feed stock; in the case of non-metals, mineralized and in the case of metals, plated to the cathode. The present invention provides an apparatus and methods which overcome some of the problems associated with the treatment of wastewater and sludge and offers a new, novel approach to the treatment of waste, by employing the use of electroplasma processing which utilizes aspects of ultraviolet blue light, thermal energy, cavitation, flocculation, aeration, and electrical energy. The ability to control flow rates, energy density, cavitation density, aeration density and heat generation within the system offers a new level of control over different materials for treatment of waste, contaminants or metals within the same process and apparatus.

### TECHNICAL FIELD

The present invention relates to devices and methods to treat fluids and/or sludge with electro-plasma. Generation of electro-plasma within a confined area causes several conditions to occur, namely, heat in the near plasma zone and plasma area in excess of 2,000° C., super cavitation (including bubble generation and implosion), ultraviolet radiation and blue light, and flocculation movement by expanding gas from the thermal reaction. Specifically, with respect to organic molecules in waste streams that come into direct contact with the plasma, these molecules are substantially or completely mineralized.

### BACKGROUND ART

U.S. Pat. No. 4,002,918 discloses a device for the irradiation of fluids in which the fluid is conducted along the walls of a container having walls which are permeable for the radiation to which the fluid is exposed. Radiation sources are arranged around the container and an active rotor is disposed within the container. The rotor is used to wipe any deposits from the container walls during treatment.

U.S. Pat. No. 4,317,041 discloses various embodiments of photo reactors in which there are at least two radiation chambers with a window arranged between. UV radiation is introduced into one of the chambers at a side opposite the window so that it passes through that chamber, through the window and into the second chamber. The fluid medium to be purified is passed through the chambers and subjected to the radiation while in the chambers.

U.S. Pat. No. 4,476,105 describes a process for producing gaseous hydrogen and oxygen from water. The process is conducted in a photolytic reactor which contains a water-suspension of a photoactive material containing a hydrogen-liberating catalyst. The reactor also includes a column for receiving gaseous hydrogen and oxygen evolved from the liquid phase. The reactor is evacuated continuously by an external pump which circulates the evolved gases through a means for selectively recovering hydrogen.

U.S. Pat. No. 5,126,111 discloses a method of removing, reducing or detoxifying organic pollutants from a fluid, water or air, by contacting the fluid with photo-reactive materials with a substance that accepts electrons and thus inhibits hole-electron recombination.

Other photo-reactors are described in U.S. Pat. Nos. 3,567,921; 3,769,517; 3,924,246; 4,488,935; 5,045,288; and 5,149,377.

U.S. Pat. No. 5,994,705 discloses a flow-through photochemical reactor that circumscribes a longitudinally extending channel having a annular cross section. This channel accommodates fluids passing between an inner wall of the reactor body and an outer wall of a photon-transmitting tube that is housed internally.

WO-A-97/35052 describes an electrolytic process in which a liquid electrolyte flows through one or more holes in an anode held at high DC voltage and plasma is formed on a cathode.

WO-A-97/35051 describes an electrolytic process for cleaning and coating electrically conducting surfaces which is similar to the process described in WO-A-97/35052 except that the anode comprises a metal for metal coating of the surface of the cathode.

WO-A-98/32892 describes a process which operates essentially in the manner described in WO-A-99/15714 but uses a conductive gas/vapor mixture as the conductive medium.

WO-01/09410 A1 describes a process similar to WO-A-98/32892 and WO-A-99/15714 and claims an improved process in which, an electro-plasma is employed to clean and or apply a metal coating to an electrically conductive surface.

### BRIEF DESCRIPTION OF THE DRAWINGS

FIG. 1 depicts a vertical reactor in accordance with the present invention.

FIG. 2 depicts a single horizontal reactor in accordance with the present invention.

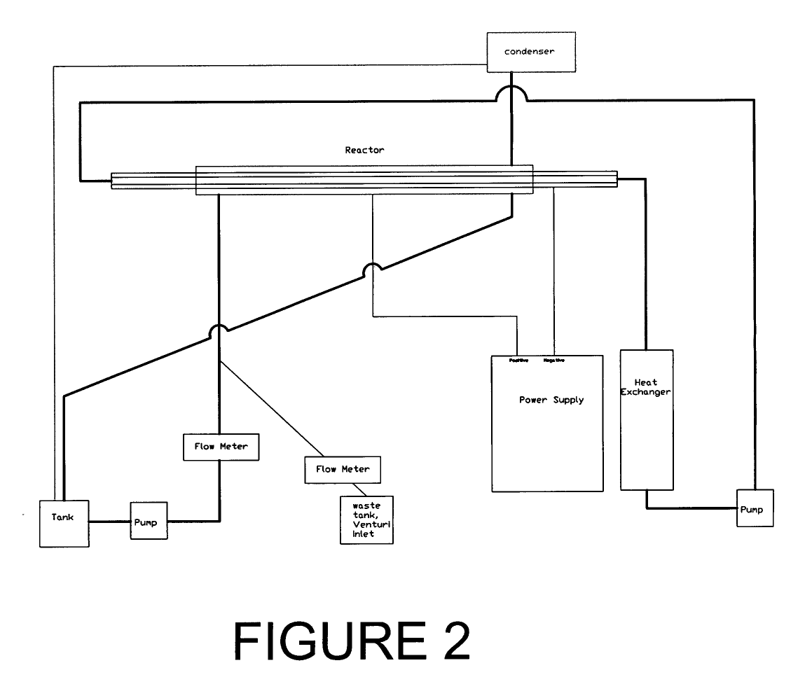

FIG. 3 depicts multiple cathode reactors in accordance with the present invention.

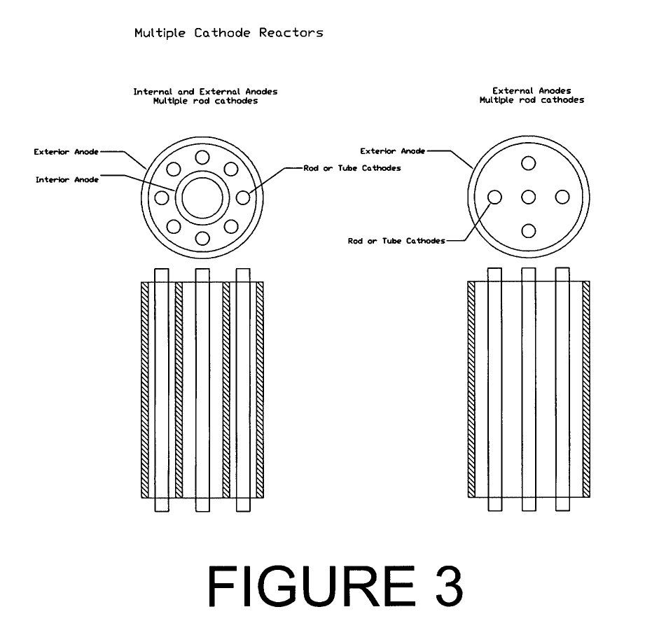

FIG. 4 depicts vertical reactors in parallel in accordance with the present invention.

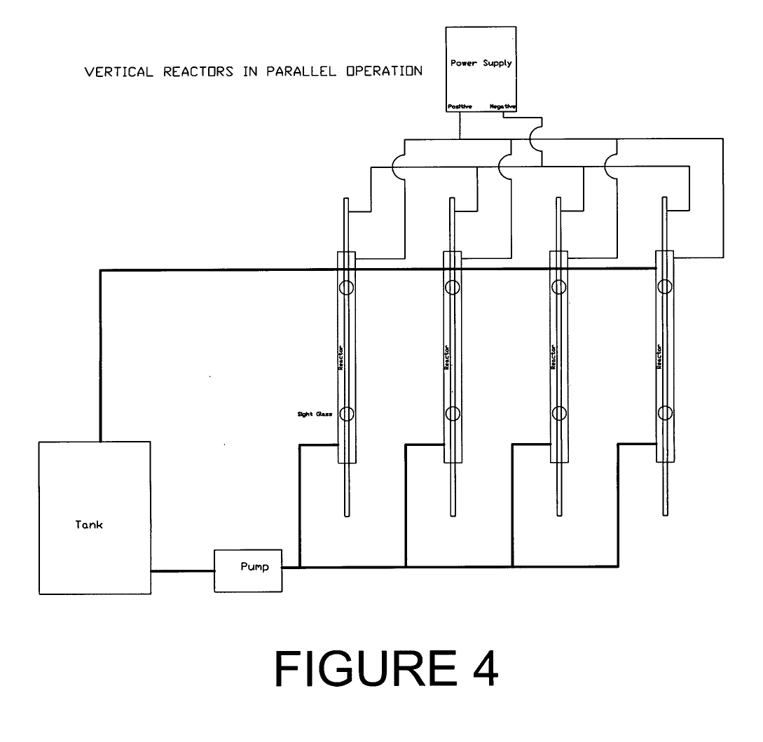

### SUMMARY OF THE INVENTION

Accordingly, a process for treating wastewater streams contaminated with one or more waste materials is provided, comprising the steps of: (a) flowing a liquid stream contaminated with said waste materials through an electrolytic cell comprised of an anode and a cathode, in which, one or the other conductive surface can be either the anode or the cathode; (b) establishing a DC voltage between the anode and the cathode; (c) forming a working gap between the anode and cathode in such a manner as to press the waste liquid tightly into the plasma zone created within the reaction chamber; (d) adjusting the operating parameters such that a glow discharge plasma occurs along the greatest possible surface area of the cathode to gain the greatest efficiency for mineralization of said waste materials and the elimination of metals within the wastewater stream as they are plated to the cathode; and (e) adjusting the venting system to allow for the escape of gas and the condensation of vapor which can be returned to the liquid stream for further treatment of discharge.

The waste materials may comprise organic, organometallic, metals, sewage sludge, and other industrial contaminants such as hydrocarbons, pathogens, volatile organic compounds, biological, and medical waste, and any material capable of being mineralized in 2,000° C. glow discharge plasma.

The apparatus is generally comprised of a reactor and the necessary components needed to introduce a waste stream to the electro-plasma reactor such that the material to be mineralized is moved into the conductive water stream and fed into the reactor so as to maximize its contact with the plasma and maintain the necessary residence time within the plasma zone which allows for the maximum amount of material to be processed with the greatest efficiency.

The process can utilize multiple conductive materials as the cathode; materials with physical properties such as porosity, high surface area compared to total volume, low resistance to electrical current and mechanical strength and toughness to resist degradation due to high operating temperatures, high flow rates, and chemical reactions. The electrical regime in which the process operates is at a point where amperage remains relatively constant as voltage increases.

The liquid waste stream may or may not be heated prior to being treated in accordance with the processes described. The gas envelope created within the plasma zone is in close proximity to the liquid waste stream by closing the working gap between the anode and cathode.

Ideally, the liquid waste stream is subjected to the greatest impact generated within the plasma zone, and the liquid is caused to experience flocculation from the rapid movement of gas bubbles within the reaction zone. Also, the waste within the liquid stream is subjected to the greatest impact from ultraviolet (UV) light created by the glow discharge plasma. Furthermore, the waste within the liquid stream is subjected to the greatest impact from the kinetic energy of the cavitation affects created as the gas within the hydrogen bubbles ionizes and the bubble implodes striking the cathode surface with great force which results in the bouncing of shock waves between the cathode surface that the surface of the gas/liquid boundary layer which exist when plasma exist.

Oxygen bubbles which form on the anode and which form from the ebullition of the liquid within the reaction zone keeps the solids suspended and moving within the reaction zone, and serves to cause more contact of the waste material with the plasma.

The pressure within the reactor can be controlled at atmospheric or above. A glow discharge plasma is produced within a conductive water stream and can therefore be embodied in situ within the industrial process that is carrying the waste stream.

Also provided is an apparatus for the purpose of creating glow discharge plasma for the removal or destruction of waste materials from a liquid stream, emulsified waste sludge stream or other waste steam capable of flowing through a reactor by means of gravity, pressure or pumping, the apparatus comprising a chamber comprised of two electrically conductive walls into which a liquid stream can be introduced; a means for converting the liquid stream into foam, a treatment zone sealed by means of a closed loop system in which a valve or control mechanism is placed at the highest point from the reaction zone; and a means for allowing vapor that has turned to condensate to be returned to the waste stream for further treatment or into the discharge line as necessary. The system also includes the ability to control pressure within the zone and allow gas to be vented if necessary and vapor to condensate.

The anode/cathode geometry is such that the outside wall of the reactor is non-conductive, forming a chamber in which the anode and cathode assembly is inside of a chamber, which isolates electrically the reaction zone. The waste stream can be delivered within the working gap with the cathode being solid, porous, or perforated. Also, the waste stream can be delivered within the working gap with the anode and cathode being in a straight line vertical position, straight line horizontal position, any straight line angle position, or as a spiral configuration.

The reactors may be operated singularly, in tandem, parallel or in a series. Multiple reactors can be individually operated or controlled by control of the electrical power to the reactor. Multiple reactors can be individually operated or controlled by diverting the waste stream from the reactor while leaving the reactor electrically charged, effectively creating an open circuit. The cathode may be a tube made from porous conductive material, in which the waste stream is introduced into the working gap from inside the cathode.

### BEST MODE OF CARRYING OUT THE INVENTION

Electro-plasma refers to the electrolytic process where a conductive medium is introduced into a space (gap) between an anode (+) and a cathode (−) and an electrical potential is added. As the voltage is increased, current also increases, and at some point electrical arcing (sparking) occurs. As the voltage increase continues, at some point, current begins to remain the same or decrease, at which point, a combination of electrical arcing and glow discharge plasma forms. As the voltage increase continues and the current continues to decrease, the electrical arcing stops and a glow discharge plasma forms and is stabilized.

This region is relatively narrow and as voltage continues to increase, current again begins to increase, glow discharge plasma generation is reduced and electrical arcing again begins to occur. The electro-plasma process (EPP) is currently being developed for the removal of oxides, in the form of scale, and other organic compounds such as paint, oil, drawing compounds, grease and chemical lubricant carriers from the surface of metals.

Within the field of this development, notice was given that many contaminants were being broken down within the process and stripped from the liquid electrolyte stream. A further application of the electro-plasma (EPP) process is the ability to apply metals to the cathode as coatings. Metals in suspension as solids or in the form of metal ions are “naturally” plated onto the cathode as a reaction within the process. Such a process is also described in U.S. Pat. No. 6,585,875.

It became apparent that many of the effects of the electro-plasma process for the cleaning and coating of metals, might also afford benefits for the treatment of contaminants in wastewater or sludge as they pass through the glow discharge plasma region.

Wastewater, sewage sludge and other industrial contaminants such as hydrocarbons, pathogens, volatile organic compounds and other solid materials require some form of treatment to meet U.S. Environmental Protection Agency (EPA) guidelines for the treatment of contaminants. A further embodiment of the process is the creation of a very strong and dense layer of bubbles, in the form of foam, which would have a similar effect as currently used air strippers for stripping volatile organic compounds (VOC) from water or spent caustic or as a simple aerator for sludge or viscous liquids. As an air stripper the VOC's would move from the liquid to the air (gas bubbles) which is vented allowing the off-gas to be vented to atmosphere or treated if necessary, while the condensed liquid is returned to the system. Should a high level of solids exist within the liquid stream, the lifting or flocculation action of the rising gas bubbles, the lift provide by this rising column of gas bubbles, is strong enough to lift any suspended solids from the column, into the condensation line and out for separation from the liquid stream.

This type of action which occurs naturally within the electro-plasma process (EPP) can be closely related to the current use of air-sparged hydrocyclone (ASH) systems, which are efficient but contain some drawbacks, such as plugging and fouling. These inherent drawbacks in the air-sparged hydrocyclone systems would be non-existent in the EPP system. The inefficiencies and problems associated with air/gas stripping systems would not only be overcome by the EPP system but other or multiple benefits would be added by use of the EPP system. The EPP system, as part of the natural process, can control the size and volume of bubbles, the flow rates through the system, the power density within the system, and the heat generated within the plasma zone. These multiple capabilities offer the feasibility for treating sewage sludge, industrial sludge, spent caustics, produced water, aerate wastewater, and mixed chemicals. The treated water, now heated, can be sent to the boiler, thus reducing the energy required to raise cooled water to steam.

The present invention provides an apparatus and methods which overcome some of the problems associated with the treatment of wastewater and sludge and offers a new, novel approach to the treatment of waste, by employing the use of electro-plasma processing which utilizes aspects of ultraviolet blue light (UV), thermal energy (heat), cavitation (kinetic), flocculation, aeration, and electrical energy. The ability to control flow rates, energy density, cavitation density, aeration density and heat generation within the system offers a new level of control over different materials for treatment with utilization of the same process and apparatus.

The apparatus generally comprises an outer tube(s) (anode) or tubes, and bars, rods or hollow rods (cathode) with entry ports, vapor ports, liquid/sludge ports, and a method to move liquid/sludge through the system, such as pumps. Also included are a method of grounding the cathode, a method of energizing the anode with DC power and a method to control or vary the input DC voltage, while current is controlled by liquid/sludge volume. Further included are a DC power source, flow control pumps, tanks, and a system of pipes and valves to move and control the flow of liquid/sludge through the system.

The present invention provides a method for stripping off-gases of volatile organic compounds (VOC's), ammonia and hydrogen sulfide. These off-gases, should they need to be burned or ignited, the hydrogen and oxygen being generated by the process will serve as a fuel additive and assist a conventional fuel such as propane, which reduces fuel cost for flaring or oxidizing the contaminants.

Liquid is passed through a cylinder or tank which is comprised of an outer containment wall, the anode and inner rods, tubes, or perforated screens in the form of tubes or as walls between chambers which are positively and negatively charged.

The liquid, containing the contaminants becomes the electrical conductor between the positive anode and the negative cathode.

Within the chamber, it is only relevant which surface is the anode and which surface is the cathode, for purposes of exposing more surface areas to plasma formation for treatment purposes rather than the ability for plasma to be formed.

The operating parameters can be adjusted to provide the necessary conditions for the establishment of an electro-plasma and these parameters include the voltage, the chemical composition of the electrolyte with regard to conductivity, the rate or volume of flow through the reactor (which impacts electrical current) and the “gap” or distance between the wall of the anode and cathode. The invention provides for an anode and a cathode which can be reversed, in that the anode can become the cathode and the cathode can become the anode without adversely affecting the formation of plasma. It also provides conditions within the working chamber to contain the foam which forms from the liquid electrolyte and which comprises the electrically conductive path between the anode and the cathode.

The present invention represents an improvement on the prior art by the use of heated electrolyte [±50° C.] which electrolyte contains some material, such as sodium carbonate (soda ash) as a method to increase electrical conductivity thereby substantially reducing the voltage required to initiate glow discharge plasma. The invention also represents an improvement on the prior art by the use of “foam” which is formed from the liquid waste stream. Such foam may be formed by boiling an aqueous electrolyte containing salts such as sodium carbonate, calcium carbonate, sodium chloride, or other minerals, compounds or metal salts. The foam, by virtue of its gas/vapor content, has a lower conductivity than the corresponding liquid electrolyte and because of this, current and voltage is reduced and overall power consumption is less, making the process more economical.

The present invention, for waste treatment, allows for the injection of the waste stream for any number of inlets or conditions; direct flow into a cylinder, cascading from the walls of a cylinder, flowing or dripping over the cathode(s), through a perforated tube which is the cathode or through a tube made from porous material which is the cathode. The waste stream, now comprised essentially of foam, may flow from one reaction chamber to another for further treatment or simply expelled as treated waste in the form of the liquid as it entered the reactor, less the contaminants.

An important aspect to the invention is the natural ability to simply flow a waste stream continuously through the plasma zone of the reactor(s). The venting of off-gases is required and the use of tubes, coiled tubes, and tanks, as condensation vessels serve to cool the off gasses and return them to the treated stream for further treatment or disposal.

A further embodiment of the invention is the treatment of wastewater, sewage sludge, industrial contaminants, hydrocarbons, pathogens, volatile organic compounds and other contaminants which are mineralized as they come into contact with the glow discharge plasma within the reaction zone. A very strong and dense layer of bubbles or foam is created, which has the same effect as conventional air strippers for stripping volatile organic compounds (VOC) from water or spent caustic or as an aerator for sludge or viscous liquids. Air stripping of VOC's moves from the liquid to the air as gas bubbles, which are vented allowing the off-gas to be vented to atmosphere or treated in a scrubber if necessary, while condensed liquid is returned to the system.

Should a high level of solids exist, the lifting or flocculation action of the rising gas bubbles would lift the suspended solids from the column, into the condensation line and out for separation from the liquid stream. This action occurs naturally within the electro-plasma process and is similar in effect to the use of air-sparged hydrocyclone (ASH) systems.

A further embodiment of the invention is the ability to control the size and volume of the bubbles, the flow rates, the power density and the heat generated within the reaction zone. These capabilities indicate the ability to treat sewage sludge, industrial sludge, spent caustic, produced water, aerate wastewater, and other waste streams. Secondary benefits from this novel process of waste treatment indicates that energy used in the process can be recovered by other in-plant processes. For example, when the treated water is heated, it can be sent to a boiler which eliminates the greatest level of energy used, which is the energy required to bring cool water to a warm level, before continuing to the boiling point.

With respect to the figures, a number of possible configurations in accordance with the present invention are depicted. Other configurations may be used, such as vertical columns in graduated length of treatment zones with first zone being the greatest. Venting of off-gas can occur at any point beginning with the first reactor.

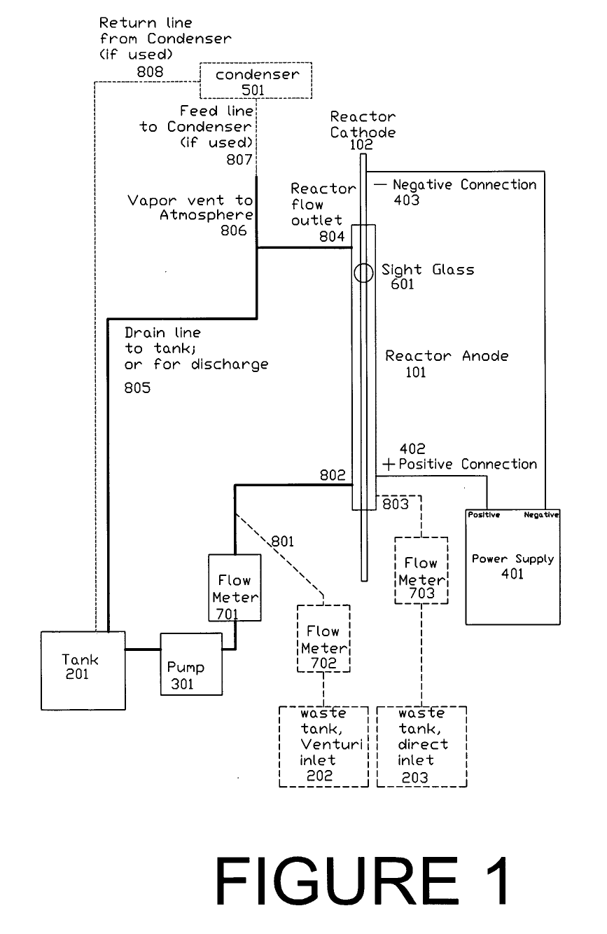

FIG. 1 depicts a vertical reactor anode (101) and a tank(s) (201), including supply tank or effluent receiving line and tanks (202 & 203) for receiving treated materials, and pump(s) to move the waste stream/sludge (301) and a DC power supply (401) with positive leads (402) and negative leads (403) and a condenser (501) for condensing the off-gas (hydrogen and carbon dioxide) back to water for return to the tank (102) and a sight glass or viewing port (601) and flow meters (701) to monitor flow rates through the system and transport lines, piping, valves (801) for moving effluent through the system, including inlet (802), outlet (804), vapor (off-gas) vent to atmosphere (806). Note that the reactors can utilize different conductive materials as the cathode, including carbon rods and additionally, the cathode may be a tubular material which would allow for the circulation of a coolant through the cathode to serve as a heat exchanger. Reactors can be placed in series or parallel and with segmented chambers, or different length chambers as determined to be suitable for the particular application and type of waste stream to be treated.

### EXAMPLES

Experiments conducted were designed to show the potential application of the electro-plasma process for the treatment of wastewater from a variety of industries. The experiments were designed and constructed to measure total organic carbon that might “break through” the reactor as feed stock concentrations were incrementally increased from 0 parts per million (ppm) and higher. Test variables included flow rates of the conductive medium, temperature of the conductive medium before entry into the reactor, conductivity of the waste stream, power density of the plasma and the effects of solubility of the organic compounds in water. As conditions are optimized for stable plasma formation the highest successful feed stock concentrations are observed.

Alkanes, such as gasoline and motor oil; aromatics such as benzene, toluene, xylene; alcohols such as ethyl, methyl, isopropyl; keytones such as methyl ethyl and acetone were run as feed stock through the plasma reactor. With the exception of the alcohols, the organic compounds listed above, in the 1700 ppm range could be fed through the reactor with no total organic carbon breakthrough. Alcohols could be fed into the reactor in the 6000 ppm range successfully and when the other compounds listed were first dissolved in alcohol and then processed, the ppm range increased to 4500 ppm.

### Example 1

A solution (water) with 35,714 ppm (parts per million) of xylene (85%) and ethyl benzene (15%) was processed using a vertical column reactor, 28 cm in length, 12.7 mm in diameter with a 5 mm diameter stainless steel rod as the cathode. Flow rates were ¼ Liter per minute, with a power density of 25.7 w/cm² of cathode surface. Conductivity of Test No. 1=14 ms, Conductivity of Test No. 2=100 ms (increased % of NaHCO₃ for test #2).

### Xylene Test Results:

Test No. 1 Final: 2660 ppb (parts per billion)
Test No. 2 Final: 67.8 ppb (parts per billion)

### Example 2

A solution (water) with 50 ppm of benzene and toluene was processed using a vertical column reactor, 28 cm in length, 12.7 mm in diameter with a 5 mm stainless steel rod as the cathode. Flow rates were ¼ to ⅜ liter per minute, with a power density of 23.4 w/cm² of cathode surface. Results: 84.4 ppb (parts per billion).

### Example 3

A solution (water) with 250 ppm of benzene and toluene was processed using a vertical reactor, 28 cm in length, 12.7 mm in diameter with a 5 mm stainless steel rod as the cathode. Flow rates were ⅜ of the liter per minute, with a power density of 24.8 w/cm² of cathode surface. Results: 554 ppb [parts per billion]

### Example 4

A solution (water) with 50 ppm xylene was processed using a vertical reactor, 28 cm in length and 12.7 mm in diameter with a 5 mm diameter stainless steel rod as the cathode. Flow rates were ¼ liters per minute, with a power density of 25.2 w/cm² of cathode surface area. Results: 67.8 ppb

### Example 5

A solution (water) with 1000 ppm of xylene was processed using a vertical reactor, 28 cm in length and 12.7 mm in diameter with a 5 mm diameter stainless steel rod as the cathode. Flow rates were ¼ to ⅜ liters per minute with a power density of 26.3 w/cm² of cathode surface area. Results: 2660 ppb.

### Example 6

A solution (water) of fifteen (15%) percent sodium carbonate was flowed through a ¼″ thick perforated lead plate (2 mm diameters holes on 6 mm centers) containing 90 holes. A gap of 12 mm was maintained between the anode (lead plate) and the cathode (carbon steel coated with red lead paint). Plasma was formed on the cathode and removed the red lead paint completely [100%]. An air filter cassette was placed within the vapor plume, twelve (12″) inches from the face of the cathode and other filter cassettes were placed at random locations, using twelve (12″) inch spacing intervals around the reactor. A flow meter to control air volume was placed between the filter cassette and the vacuum pump. Air flow into the filter canister was metered at 0.2 ft/second. Total emission capture time, 23.66 minutes. Results: Lead emissions, at 12 inches from the cathode, in the vapor plume, to the atmosphere were 0.025 g/ft² or eleven (11%) percent of the total allowable maximum for air quality. Dispersion Sphere Radius analysis with no detection outside of the plume area.

### Example 7

To tap water, lead sulfate powder was mixed at a concentration of 10% lead sulfate by weight. The liquid was then used as the electrolyte for processing. The electrolyte was captured and not allowed to return to the mixing tank, but recycled through the reactor for approximately five minutes of operating time. A water sample taken from the initial bath, before processing showed slightly less than 10% soluble lead. A water sample taken after processing for approximately five minutes was analyzed and showed less than 2% soluble lead in solution.

### Example 8 & 9

The same tests as conducted for Example 6 was conducted using zinc and then aluminum. Aluminum vapor samples were below the detection limits (none found) and zinc levels were extremely low at 1.8 ppb within the plume (12″ from the cathode).

### Example 10

A reactor 50.8 mm in diameter, 609 mm long with a stainless steel rod 19.5 mm in diameter as the cathode was used continuously for approximately 100 minutes of processing of different waste materials; benzene, toluene, xylene, motor oil, methyl ethyl ketone, ethanol and xylol. The cathode rod was removed from the reactor and cleaned in hot water, after which three (3) samples were cut from the cathode; Specimen 1 virgin material outside of the reaction zone, Specimen 2 labeled Sample B (three parts) which is located in the lower plasma zone, where electrolyte first enters the reactor and Specimen 3, labeled Sample T (three parts) which is located in the upper plasma zone. Electron Dispersive X-ray Analysis [EDAX] was conducted on each specimen.

Results: The virgin specimen contained the typical composition for 316 SS, Mn, Si, Mo, Cr, Ni, & Fe. The results for the samples inside the reaction zone showed the following: Sample B, (lower b, c & d) Zinc, Aluminum, Copper and Calcium along with the typical elements for 316 SS. The results for Sample T (upper b, c & d) Zinc, Aluminum, Copper and Calcium. Sample T showed a significant increase in the Zinc, Aluminum, Copper and Calcium deposits which is consistent with plasma formation and density within the reactor and strongly indicates that trace metals in the electrolyte are being removed by plating to the cathode.

### Example 11

A reactor as described in example 10 above with an electrolytic solution of 7% sodium bicarbonate and water feed was tested with a variety of organic compounds individually and as a mixture. The reactor was operated in a mode such that 100% of the organic material was mineralized (completely destroyed, with compounds being reduced to their constituent elements). The feed concentration was slowly increased until sensitive instrumentation determined that reactor break-through of any one of the compounds had just occurred. At that point, feed concentration was reduced just to the point where total organic carbon detected was zero. The instrumentation used was a combination of photo-ionization and flame ionization detection apparatus with detectable limits on the order of a few ppb (parts per billion). The compounds tested were: Alkanes; gasoline components, motor oil; Aromatics; Benzene, Toluene, Xylene; Alcohols; Ethyl Alcohol, Methyl Alcohol, Isopropyl Alcohol; Keytones; Methyl Ethyl Keytone, Acetone. All of the compounds above behaved essentially the same with the exception of the Alcohols. Break-through occurred at ˜2000 ppm (part per million) in all cases. These compounds generally have a solubility of ˜400 ppm in water. The Alcohols had a much better result, ˜6000 ppm for breakthrough. These alcohols are generally completely miscible in water, that is to say they are 100% soluble in water. Further, it was found that when all the other compounds where first dissolved in Alcohol and then feed to the reactor, break-through occurred at ˜4500 ppm. This may indicate a correlation between solubility of a material in water and the efficiency with which it is destroyed indicating that more organic molecules had an opportunity to interact with the glow discharge plasma in this case. GCMS was run by an independent laboratory to determine what if any organic molecules appeared in the effluent streams. GCMS is an extremely sensitive test with the added feature that compounds can be identified by name in the event that any are detected. Only one compound was observed in the trace ppb range, MEK (Methyl Ethyl Keytone), one of the compounds in the feed stream. GCMS is much more sensitive than the detectors used as part of the experiment. The GCMS analysis was utilized to verify the result observed for break-through and determine specifically what compound(s) had break-through. It is possible that in an electro-chemical process such as this that reactions leading to much more complicated species can occur. The fact that they did not is further evidence of a complete mineralization of the compounds present in the feed.

Although exemplary embodiments of the present invention have been shown and described, many changes, modifications, and substitutions may be made by one having ordinary skill in the art without necessarily departing from the spirit and scope of the invention.

What is claimed is:

1. A process for treating wastewater streams contaminated with one or more waste materials, comprising the steps of:
(a) flowing a liquid stream contaminated with said waste materials through an electrolytic cell comprised of an anode and a cathode, in which, one or the other conductive surface can be either the anode or the cathode;
(b) establishing a DC voltage between the anode and the cathode;
(c) forming a working gap between the anode and cathode in such a manner as to press the waste liquid tightly into the plasma zone created within the reaction chamber;
(d) adjusting the operating parameters such that a glow discharge plasma occurs along the greatest possible surface area of the cathode to gain the greatest efficiency for mineralization of said waste materials and the elimination of metals within the wastewater stream as they are plated to the cathode;
(e) adjusting the venting system to allow for the escape of gas and the condensation of vapor which can be returned to the liquid stream for further treatment of discharge.

2. The method of claim 1, wherein said waste materials may comprise organic, organometallic, metals, sewage sludge, and other industrial contaminants such as hydrocarbons, pathogens, volatile organic compounds, biological, and medical waste, and any material capable of being mineralized in 2,000° C. glow discharge plasma.

3. A process, as claimed in claim 1, which is comprised of a reactor and the necessary components needed to introduce a waste stream to the electro-plasma reactor such that the material to be mineralized is moved into the conductive water stream and fed into the reactor so as to maximize its contact with the plasma and maintain the necessary residence time within the plasma zone which allows for the maximum amount of material to be processed with the greatest efficiency.

4. A process, as claimed in claim 1, that can utilize multiple conductive materials as the cathode; materials with physical properties such as porosity, high surface area compared to total volume, low resistance to electrical current and mechanical strength and toughness to resist degradation due to high operating temperatures, high flow rates, and chemical reactions.

5. A process, as claimed in claim 1, where the electrical regime in which the process operates is at a point where amperage remains relatively constant as voltage increases.

6. A process, as claimed in claim 1, in which the liquid waste stream may or may not be heated.

7. A process, as claimed in claim 1, in which the gas envelope created within the plasma zone is in close proximity to the liquid waste stream by closing the working gap between the anode and cathode.

8. A process, as claimed in claim 1, in which the liquid waste stream is subjected to the greatest impact generated within the plasma zone, and where the liquid is caused to experience flocculation from the rapid movement of gas bubbles within the reaction zone.

9. A process, as claimed in claim 1, in which the waste within the liquid stream is subjected to the greatest impact from ultraviolet (UV) light created by the glow discharge plasma.

10. A process, as claimed in claim 1, in which the waste within the liquid stream is subjected to the greatest impact from the kinetic energy of the cavitation affects created as the gas within the hydrogen bubbles ionizes and the bubble implodes striking the cathode surface with great force which results in the bouncing of shock waves between the cathode surface that the surface of the gas/liquid boundary layer which exist when plasma exist.

11. A process, as claimed in claim 1, in which oxygen bubbles which form on the anode and which form from the ebullition of the liquid within the reaction zone keeps the solids suspended and moving within the reaction zone, and serves to cause more contact of the waste material with the plasma.

12. A process, as claimed in claim 1, in which the pressure within the reactor can be controlled at atmospheric or above.

13. A process, as claimed in claim 1, in which a glow discharge plasma is produced within a conductive water stream and can therefore be embodied in situ within the industrial process that is carrying the waste stream.

14. An apparatus for the purpose of creating glow discharge plasma for the removal or destruction of waste materials from a liquid stream, emulsified waste sludge stream or other waste steam capable of flowing through a reactor by means of gravity, pressure or pumping, the apparatus includes:
a chamber comprised of two electrically conductive walls into which a liquid stream can be introduced,
a means for converting the liquid stream into foam, a treatment zone sealed by means of a closed loop system in which a valve or control mechanism is placed at the highest point from the reaction zone, a means for allowing vapor that has turned to condensate to be returned to the waste stream for further treatment or into the discharge line as necessary.

15. An apparatus, as claimed in claim 13, to control pressure within the zone and allow gas to be vented if necessary and vapor to condensate.

16. An apparatus, as claimed in claim 13, in which the anode/cathode geometry is such that the outside wall of the reactor is non-conductive, forming a chamber in which the anode and cathode assembly is inside of a chamber, which isolates electrically the reaction zone.

17. An apparatus, as claimed in claim 13, in which the waste stream can be delivered within the working gap with the cathode being solid, porous, or perforated.

18. An apparatus, as claimed in claim 13, in which the waste stream can be delivered within the working gap with the anode and cathode being in a straight line vertical position, straight line horizontal position, any straight line angle position, or as a spiral configuration.

19. An apparatus, as claimed in claim 13, in which reactors are operated singularly, in tandem, parallel or in a series.

20. An apparatus, as claimed in claim 13, in which multiple reactors can be individually operated or controlled by control of the electrical power to the reactor.

21. An apparatus, as claimed in claim 13, in which multiple reactors can be individually operated or controlled by diverting the waste stream from the reactor while leaving the reactor electrically charged, effectively creating an open circuit.

22. An apparatus, as claimed in claim 13, in which the cathode is a tube made from porous conductive material, in which the waste stream is introduced into the working gap from inside the cathode.
